(19) United States
(12) Patent Application Publication
(10) Pub. No.: US 2025/0292054 A1
(43) Pub. Date: Sep. 18, 2025

(54) TECHNIQUES TO PROCESS TRANSACTIONS WITH A CONTACTLESS CARD BASED ON ONE OR MORE CONFIGURATIONS OF THE CONTACTLESS CARD

(71) Applicant: Capital One Services, LLC, McLean, VA (US)

(72) Inventors: Colin HART, Arlington, VA (US); Jeffrey RULE, Chevy Chase, MD (US); Lea CODY, Arlington, VA (US); Kaitlin NEWMAN, Washington, DC (US)

(73) Assignee: Capital One Services, LLC, McLean, VA (US)

(21) Appl. No.: 19/027,600

(22) Filed: Jan. 17, 2025

Related U.S. Application Data
(63) Continuation of application No. 17/140,901, filed on Jan. 4, 2021, now abandoned.

(51) Int. Cl. G06K 19/07; G06Q 20/10; G06Q 20/20; G06Q 20/34; G06Q 20/40

(52) U.S. Cl. CPC G06K 19/0718; G06Q 20/1085; G06Q 20/204; G06Q 20/3563; G06Q 20/3574; G06Q 20/4015; G06Q 20/405; G06Q 20/4093

(57) ABSTRACT

Embodiments may be generally directed to techniques, systems, and devices to control settings stored on contactless cards.

### RELATED APPLICATIONS

This application is a Continuation of U.S. patent application Ser. No. 17/140,901, filed on Jan. 4, 2021. The contents of the aforementioned patent application is incorporated herein by reference in its entireties.

### BACKGROUND

Millions of individuals enjoy the convenience of utilizing credit cards, charge cards, debit cards, and/or currency or “smart” cards as a convenient way in which to purchase goods and/or services. By utilizing credit cards, charge cards, debit cards, and/or currency or “smart” cards, an individual may enter into a transaction without having to have cash or currency in hand or otherwise. In the case of credit cards, charge cards and debit cards, the individual, in effect obtains an instant loan of the funds needed to make a purchase and/or enter into a transaction.

Unfortunately, with the conveniences provide by using of credit cards, charge cards, debit cards, etc., comes disadvantages and the opportunity for theft and/or fraud. In the case of credit cards, charge cards and/or debit cards, hundreds of millions, if not billions, of dollars a year are lost as a result of the theft of, and/or the fraudulent use of, credit cards, charge cards and/or debit cards, or the account numbers which correspond thereto.

A lost or stolen card may be utilized by an unauthorized individual to spend upwards of thousands of dollars before the unauthorized use is detected and/or before the cardholder can ascertain, and/or be notified, either by the card issuer or servicing institution or when the cardholder detects the unauthorized transaction on his or her monthly account statement, that the card is lost or stolen. One way to combat lost and/or stolen cards and limit the amount of money that may be stolen is to keep the spending limits on the cards low. However, this is inconvenient to customers when they want to spend more than what is available or set by their spending limit. Embodiments discussed herein address these issues.

### BRIEF SUMMARY

Embodiments may be generally directed to techniques, and systems including a contactless card having a biometric sensor to detect biometric inputs, a processor, and a memory. The memory includes instructions for a payment applet and a verification applet, the instructions that when executed by the processor, cause the payment applet to detect a request to change a setting on the contactless card, wherein the setting corresponds to limits set for transactions performed with the contactless card, and initiate a verification routine with the verification applet, the verification routine to verify a user based on a verified biometric sample stored in the memory. In embodiments, the verification routine is configured to receive a biometric sample via the biometric sensor, retrieve the verified biometric sample from the memory, and compare the biometric sample with the verified biometric sample to verify the user. The processor to execute the instructions for the payment applet to change the setting in response to the biometric sample matching the verified biometric sample based on the comparison, or prevent changing the setting in response to the biometric sample not matching the verified biometric sample based on the comparison.

Embodiments may also include a method including detecting a request to change a setting on a contactless card, wherein the setting corresponds to limits set for transactions performed with the contactless card, and initiating a verification routine to verify a user of the contactless card based on a verified biometric sample stored in a memory of the contactless card. The method also including updating the setting in response to a biometric sample matching a verified biometric sample on the contactless card or preventing change of the setting in response to the biometric sample not matching the verified biometric sample.

Embodiments may also include techniques and systems including a processor to receive a request to change a setting on a contactless card, wherein the setting corresponds to limits set for transactions performed with the contactless card, and the request is received from one of a point-of-sale terminal, an automatic teller machine (ATM), or a mobile phone device, initiate a prompt for a user to provide a biometric sample via a biometric sensor implemented on the contactless card, receive the biometric sample via the biometric sensor, and retrieve a verified biometric sample from the memory implemented on the contactless card, and compare the biometric sample with the verified biometric sample to verify the user. In embodiments, the processor to change the setting in response to the biometric sample matching the verified biometric sample based on the comparison or prevent changing the setting in response to the biometric sample not matching the verified biometric sample based on the comparison.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a contactless card 100 in accordance with one embodiment.

FIG. 2 illustrates a contactless card component 200 in accordance with one embodiment.

FIG. 3 illustrates an aspect of the subject matter in accordance with one embodiment.

FIG. 4 illustrates a logic flow 400 in accordance with one embodiment.

FIG. 5 illustrates a logic flow 500 in accordance with one embodiment.

FIG. 6 illustrates a logic flow 600 in accordance with one embodiment.

FIG. 7 illustrates a sequence flow 700 in accordance with one embodiment.

FIG. 8 illustrates a data structure 800 in accordance with one embodiment.

FIG. 9 illustrates a computer architecture 900 in accordance with one embodiment.

FIG. 10 illustrates a communications architecture 1000 in accordance with one embodiment.

### DETAILED DESCRIPTION

Various embodiments may be generally directed to providing a contactless card configured with storage to store one or more settings that may be applied to transactions. The settings may include one or more limits on transactions, and the contactless card may enable and prevent a transaction occurring based on a determination as to whether the transaction exceeds or is within the limits. The contactless card may include circuitry and logic to enable applying the settings to transactions in real-time, e.g., as a transaction is occurring.

In some instances, the contactless card may be configured with a device, such as a biometric input device, to enable a user to override a setting or limit for a particular transaction. For example, if the contactless card determines that the transaction is not within the limits set on the contactless card, the contactless card may provide an indication for a user to provide a biometric sample via the biometric input device. The contactless card including the storage may include one or more verified biometric samples and may compare the provided biometric sample to the stored verified biometric samples. If the provided sample matches a verified sample, the contactless card may permit the transaction to occur even if the transaction characteristic exceeds the limits.

Further, embodiments also include enabling a user to change one or more settings or limits on the contactless card. Thus, a user may make the limits more or less strict. The contactless card may perform a verification process, e.g., via the biometric sensor, to enable a user to update a setting. These and other details will become more apparent in the following description.

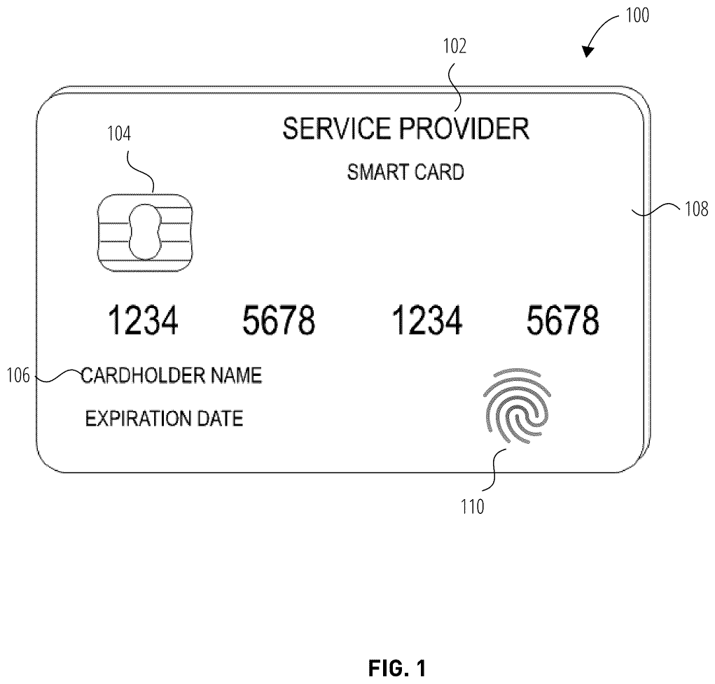

FIG. 1 illustrates an example configuration of a contactless card 100, which may be a physical card and include a contactless card, a payment card, such as a credit card, debit card, or gift card, issued by a service provider as displayed as service provider indicia 102 on the front or back of the contactless card 100. In some examples, the contactless card 100 is not related to a payment card and may include, without limitation, an identification card. In some examples, the contactless card may include a dual interface contactless payment card, a rewards card, and so forth. The contactless card 100 may include a substrate 108, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 100 may have physical characteristics compliant with the ID-1 format of the ISO/IEC 7816 standard, and the contactless card may otherwise be compliant with the ISO/IEC 14443 standard. However, it is understood that the contactless card 100, according to the present disclosure, may have different characteristics, and the present disclosure does not require a contactless card to be implemented in a payment card.

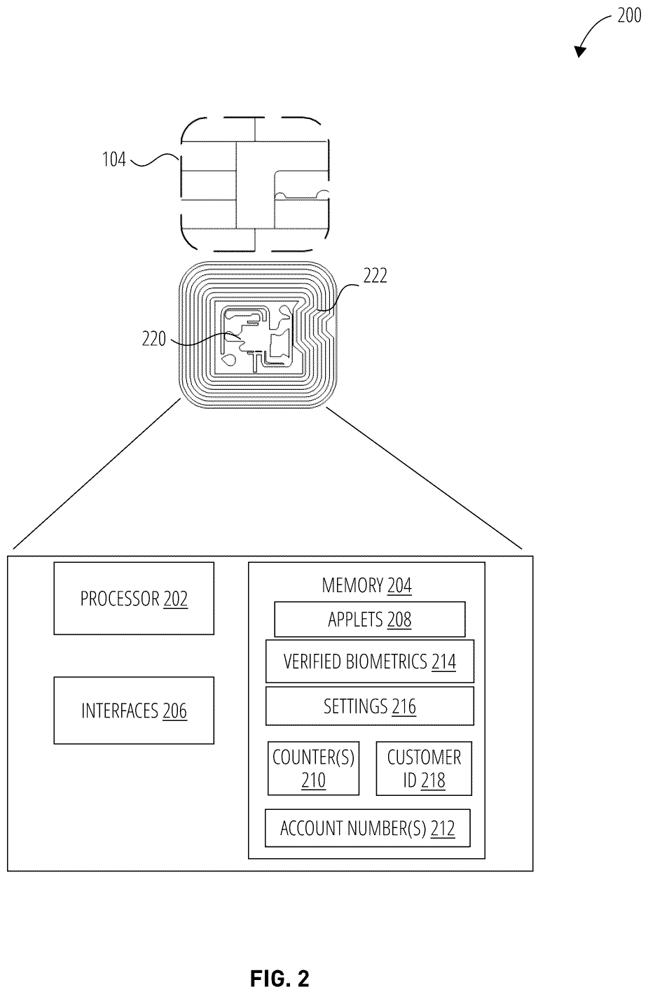

The contactless card 100 may also include identification information 106 displayed on the front and/or back of the card, and a contact pad 104. The contact pad 104 may include one or more pads and be configured to establish contact with another client device, such as an ATM, a user device, smartphone, laptop, desktop, or tablet computer via contactless cards. The contact pad may be designed in accordance with one or more standards, such as ISO/IEC 7816 standard, and enable communication in accordance with the EMV protocol. The contactless card 100 may also include processing circuitry, wireless interface circuitry, an antenna, and other components, as will be further discussed in FIG. 2. These components may be located behind the contact pad 104 or elsewhere on the substrate 108, e.g., within a different layer of the substrate 108, and may electrically and physically coupled with the contact pad 104. The contactless card 100 may also include a magnetic strip or tape, which may be located on the back of the card (not shown in FIG. 1). The contactless card 100 may also include a Near-Field Communication (NFC) device coupled with an antenna capable of communicating via the NFC protocol. Embodiments are not limited in this manner.

In embodiments, the contactless card 100 may include a biometric sensor 110 to collect biometric samples of users for verification operations. The biometric sensor 110 may be embedded in one or more layers of the substrate 108 of the contactless card 100. The biometric sensor 110 may include an interface located on the surface of the contactless card 100 and may be configured to capture the biometric samples of the user. In one example, the biometric sensor 110 may be a fingerprint sensor and may be configured to capture fingerprint samples from a user of the contactless card 100. The fingerprint sensor may be any type of fingerprint sensor, including an optical scanner, a capacitance scanner, an ultrasonic scanner, and a thermal scanner. Embodiments are not limited fingerprint sensors, and in embodiments the biometric sensor 110 may be a different type of biometric sensors, such as an iris scanner, a camera for facial recognition, and so forth.

In embodiments, the biometric sensor 110 may include circuitry and logic to process data for biometric samples. Although not shown, at least a portion of the circuitry and logic to process data relating to biometric samples may be implemented in processing circuitry 220. The biometric sensor 110 may be configured to capture a biometric sample and convert the data into a format readable by other components and applets of the contactless card 100. The data may be provided to the other components and applets for further processing. In one specification example, the biometric sensor 110 may capture the biometric sample, convert the sample into data processable by the verification applet, such as in accordance with the Java® Card application programming interface (API) and Java® Card Framework (javacard.framework), and communicate the data to the verification applet. Communicating the data may include storing the data in a memory location accessible to the verification applet. The verification applet may utilize the biometric sample and data to perform verification operations, as will be discussed in more detail below in FIG. 2. Moreover, embodiments are not limited to utilizing the Java® Card API, and embodiments may include utilizing a multi-application smart card operating system (MULTOS), Windows® for Smart Cards, Visual Basic, and other card operating systems.

As illustrated in FIG. 2, the contact pad 104 of the contactless card 100 may include processing circuitry 220 for storing, processing, and communicating information, including a processor 202, a memory 204, and one or more interfaces 206. It is understood that the processing circuitry 220 may contain additional components, including processors, memories, error and parity/CRC checkers, data encoders, anticollision algorithms, controllers, command decoders, security primitives and tamper-proofing hardware, as necessary to perform the functions described herein.

The memory 204 may be a read-only memory, write-once read-multiple memory or read/write memory, e.g., RAM, ROM, and EEPROM, and the contactless card 100 may include one or more of these memories. In embodiments, the memory 204 may include a combination of different types of memory, e.g., read-only memory, and read/write memory. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 204 may be secured or encrypted memory utilizing an encryption algorithm executed by the processor 202 to encrypted data. For example, a portion of highly important data, such as account number(s) 212 and verified biometric samples 214 may be stored in a secured memory.

The memory 204 may be configured to store one or more applets 208, one or more counter(s) 210, a customer identifier 218, the account number(s) 212, which may be virtual account numbers, and one or more verified biometric samples 214. The one or more applets 208 may comprise one or more software applications configured to execute on the contactless contactless card 100, such as a Java® Card applet. However, it is understood that applets 208 are not limited to Java Card applets, and instead may be any software application operable on contactless cards or other devices having limited memory. The one or more counter(s) 210 may comprise a numeric counter sufficient to store an integer. The customer identifier 218 may comprise a unique alphanumeric identifier assigned to a user of the contactless card 100, and the identifier may distinguish the user of the contactless card from other contactless card users. In some examples, the customer identifier 218 may identify both a customer and an account assigned to that customer and may further identify the contactless card 100 associated with the customer's account. As stated, the account number(s) 212 may include thousands of one-time-use virtual account numbers associated with the contactless card 100. In embodiments, one of the applets 208 of the contactless card 100 may be configured to manage the account number(s) 212 (e.g., to select an account number(s) 212, mark the selected account number(s) 212 as used, and transmit the account number(s) 212 to a mobile device for autofilling by an autofilling service.

The processor 202 and memory elements of the foregoing exemplary embodiments are described with reference to the contact pad 104, but the present disclosure is not limited thereto. It is understood that these elements may be implemented outside of the contact pad 104 or entirely separate from it or as further elements in addition to processor 202 and memory 204 elements located within the contact pad 104.

In some examples, the contactless card 100 may comprise one or more antenna(s) 222. The one or more antenna(s) 222 may be placed within the contactless card 100 and around the processing circuitry 220 of the contact pad 104. For example, the one or more antenna(s) 222 may be integral with the processing circuitry 220, and the one or more antenna(s) 222 may be used with an external booster coil. As another example, the one or more antenna(s) 222 may be external to the contact pad 104 and the processing circuitry 220.

In an embodiment, the coil of contactless card 100 may act as the secondary of an air-core transformer. The terminal may communicate with the contactless card 100 by cutting power or amplitude modulation. The contactless card 101 may infer the data transmitted from the terminal using the gaps in the contactless card's power connection, which may be functionally maintained through one or more capacitors. The contactless card 100 may communicate back by switching a load on the contactless card's coil or load modulation. Load modulation may be detected in the terminal's coil through interference. More generally, using the antenna(s) 222, processor 202, and/or the memory 204, the contactless card 101 provides a communications interface to communicate via NFC, Bluetooth, and/or Wi-Fi communications.

As explained above, contactless card 100 may be built on a software platform operable on smart cards or other devices having limited memory, such as JavaCard, and one or more or more applications or applets may be securely executed. Applets 208 may be added to contactless cards to provide a one-time password (OTP) for multifactor authentication (MFA) in various mobile application-based use cases. Applets 208 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applets 208 may be configured to encode the OTP as an NDEF type 4 well-known type text tag. In some examples, NDEF messages may comprise one or more records. The applets 208 may be configured to add one or more static tag records in addition to the OTP record.

In some examples, the one or more applets 208 may be configured to emulate an RFID tag. The RFID tag may include one or more polymorphic tags. In some examples, each time the tag is read, different cryptographic data is presented that may indicate the authenticity of the contactless card. Based on the one or more applets 208, an NFC read of the tag may be processed, the data may be transmitted to a server, such as a server of a banking system, and the data may be validated at the server.

In some examples, the contactless card 100 and server may include certain data such that the card may be properly identified. The contactless card 100 may include one or more unique identifiers (not pictured). Each time a read operation takes place, the counter(s) 210 may be configured to increment. In some examples, each time data from the contactless card 100 is read (e.g., by a mobile device), the counter(s) 210 is transmitted to the server for validation and determines whether the counter(s) 210 are equal (as part of the validation) to a counter of the server.

The one or more counter(s) 210 may be configured to prevent a replay attack. For example, if a cryptogram has been obtained and replayed, that cryptogram is immediately rejected if the counter(s) 210 has been read or used or otherwise passed over. If the counter(s) 210 has not been used, it may be replayed. In some examples, the counter that is incremented on the card is different from the counter that is incremented for transactions. The contactless card 101 is unable to determine the application transaction counter(s) 210 since there is no communication between applets 208 on the contactless card 100.

In some examples, the counter(s) 210 may get out of sync. In some examples, to account for accidental reads that initiate transactions, such as reading at an angle, the counter(s) 210 may increment but the application does not process the counter(s) 210. In some examples, when a device is woken up, the NFC may be enabled and the device may be configured to read available tags, but no action is taken responsive to the reads.

To keep the counter(s) 210 in sync, an application, such as a background application, may be executed that would be configured to detect when the mobile device 110 wakes up and synchronize with the server of a banking system indicating that a read that occurred due to detection to then move the counter 210 forward. In other examples, Hashed One Time Password may be utilized such that a window of mis-synchronization may be accepted. For example, if within a threshold of 10, the counter(s) 210 may be configured to move forward. But if within a different threshold number, for example, within 10 or 1000, a request for performing re-synchronization may be processed, which requests via one or more applications that the user tap, gesture, or otherwise indicate one or more times via the user's device. If the counter(s) 210 increases in the appropriate sequence, then it possible to know that the user has done so.

The key diversification technique described herein with reference to the counter(s) 210, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 100, two cryptographic keys may be assigned uniquely per card. The cryptographic keys may comprise symmetric keys that may be used in both encryption and decryption of data. Triple DES (3DES) algorithm may be used by EMV and it is implemented by hardware in the contactless card 100. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 101 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

In some embodiments, the one or more applets 208 may include a payment applet and a verification applet, each which may be logic implemented in software, e.g., in accordance a framework such as the Java® Card framework. The payment applet may include instructions to perform various operations to process transactions and data relating to transactions. The verification applet may include instructions to perform verification operations to verify users of the contactless card 100, e.g., via biometric sensor 110 of the contactless card 100. The verification applet and the payment applet also include instructions to send messages (API or function calls) between each other to perform transactions and update the card, as will be discussed in more detail below.

The payment applet is configured to perform transactions, including receiving and processing data corresponding to a transaction received via one of the interfaces 206, such as the NFC device or EMV device. In embodiments, the contactless card 100 may come within the wireless communication range of a computing device, such as an NFC operating range, and may be energized via the electrical signal emitted by the computing device. The contactless card 100 may establish a wireless communication link with the computing device by exchanging one or more messages, e.g., an NFC message exchange. The contactless card 100 may receive data corresponding to a transaction, and the payment applet may execute to process the data. For example, the payment applet may retrieve an account number(s) 212 from memory 204 and provide the account number(s) 212 to the computing device via one or more NFC messages.

In some embodiments, the contactless card 100 may include one or more settings or limits that may be applied to transactions. The payment applet may process the data corresponding to the transaction in accordance with the one or more setting and limits. The limits may include a single transaction spending limit, a total transaction spending limit, a geolocation limit, a date/time limit, and so forth. The single transaction spending limit may be a total dollar amount allowed for a given transaction, e.g., $500/transaction. The total transaction spending limit may be a total amount allowed for a given period of time, e.g., $2,000/day. The geolocation limit may define an area permitted to perform a transaction. The area may be defined by a location, such as a zip code, a city, state, etc., a specific retailer or provider of goods, and so forth. The settings 216 may be stored in the memory 204, and the payment applet may retrieve them from the memory 204 when processing the transaction to compare with the characteristics of the transaction.

In some instances, the payment applet determines that the characteristics of a transaction are within the limits to perform transaction. Specifically, the payment applet may retrieve limit values from the settings 216 stored in the memory 204 of the contactless card 100 and compare the characteristics to the limit values. The payment applet may enable the transaction to proceed when the characteristics of the transaction are within the limits. For example, the payment applet may communicate data to a computing device, and the computing device may use the data to process the transaction. The data may include account information or an account token, identifying information to identifier a user, a card verification value (CVV), an expiration date, and so forth.

In embodiments, the payment applet may determine that at least one of the characteristics of the transaction exceeds at least one of the limit values. In response, the payment applet may decline the transaction, e.g., send a message to the computing device declining the transaction. In some instances, the message may include information indicating that a limit set on the contactless card 100 is exceeded for the transaction. The contactless card 100 may be configured to enable a user to override a setting or limit when performing the transaction. For example, the contactless card 100 may be configured to receive a biometric sample via the biometric sensor 110, perform a verification operation via the verification applet, and, if the sample is successfully verified, the payment applet enables the computing device to process the transaction. Specifically, the payment applet may send data to the computing device to process the transaction.

In embodiments, the payment applet may cause an indication to be presented to the user to provide the biometric sample. For example, the payment applet may cause a light-emitting diode (not shown) on the contactless card 100 to light up, cause the computing device to display a message by sending data to the computing device, and so forth. In some instances, the biometric sample may be automatically collected by the contactless card 100. For example, a user may place his or her finger on the biometric sensor 110 when they are performing a transaction and the sample may be automatically collected.

The contactless card 100 may also include a verification applet to perform verification operations to verify one or more users. As discussed, the verification applet may execute and perform a verification operation to enable a user to perform a transaction when one or more characteristics of the transaction exceed one or more limits set for transactions. For example, the payment applet may call and initiate the verification applet when a characteristic exceeds a limit. The verification operation may collect a biometric sample from the user via the biometric sensor 110 of the contactless card 100 and compare the sample to the verified biometric samples 214 stored in memory 204. The verification applet may determine whether the sample matches the verified biometric samples 214 with a degree of certainty, e.g., 99% match. The verification applet may provide a result to the payment applet, either indicating the sample matches the verified biometric samples 214 or does not match the verified biometric samples 214.

The verified biometric samples 214 may be stored in memory 204 in a secure manner, e.g., encrypted using an encryption algorithm. In embodiments, a user may provide the verified biometric samples 214 at the time the card is issued, e.g., as part of an application process. In other instances, the verified biometric samples 214 may be updated from time-to-time. In one example, a user may update the verified biometric samples 214 using a mobile device. The mobile device may include a biometric sensor configured to capture the fingerprints of a user. The mobile device may execute an app, such as a banking app, that may include an operation to update the verified biometric samples 214. Specifically, the mobile device may capture one or more biometric samples from the user. The mobile device may verify the samples by the user by another verification, e.g., having the user enter a password. The mobile device may update the verified biometric samples 214 as part of an NFC exchange. In some instances, the verified biometric samples 214 may be updated at a banking terminal or automatic teller machine. Embodiments are not limited in this manner.

In some embodiments, the contactless card 100 may be configured to store verified biometric samples 214 for multiple users, and each of the users may be associated with different limit values that they may authorize with providing a biometric sample. For example, the contactless card 100 may store verified biometric samples 214 for a first user, such as a parent, and a second user, such as a child. The parent may have different limits than the child. For example, the parent may have a higher single transaction spending limit than the child. Similarly, the parent may have a higher total transaction spending limit than a child. A child may have a more limited geolocation limit than a parent. Similarly, a child may be limited to a certain date/time to perform transactions. Embodiments are not limited in this manner and the limits may be set in any configuration for a number of users of the contactless card 100.

To process a transaction on a contactless card 100 having multiple users, the payment applet may receive transaction data from a computing device and initiate a verification routine. The verification applet may process a capture a biometric sample. The verification applet may perform the verification operation and compare the biometric sample to each of the verified biometric samples 214 until a match occurs or determine that there are no more verified biometric samples 214. The verification applet may provide an identifier of the verified user to the payment applet, and the payment applet may utilize the identifier to determine associated limits. The payment applet may then determine if the characteristics for the transaction are within the limits for the particular user and enable or decline the transaction accordingly. If the user cannot be verified or if one of the limits for the transaction exceeds one of the limit values set for the verified user, the payment applet may decline the transaction.

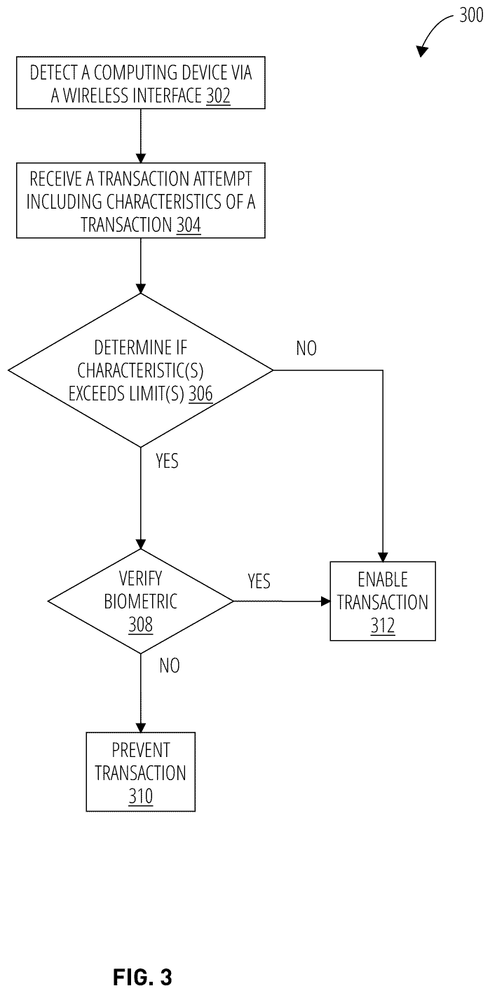

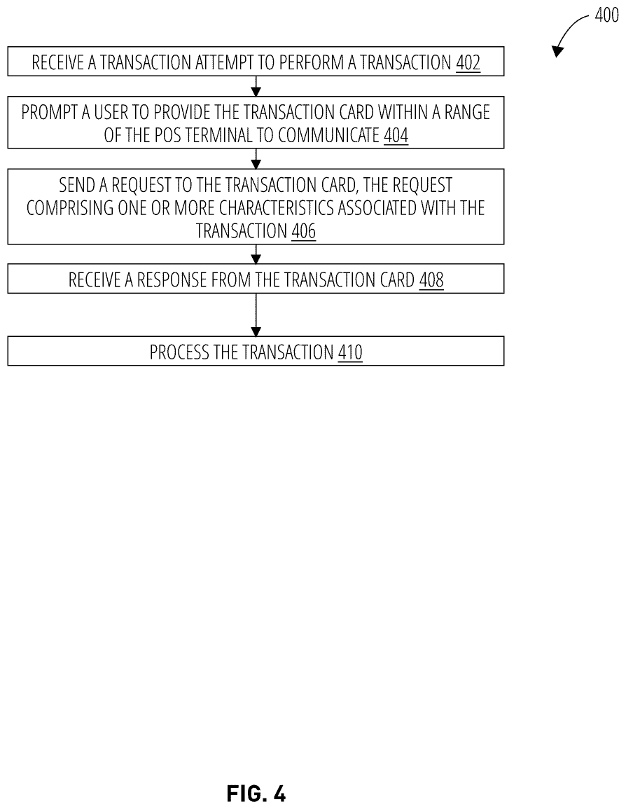

FIGS. 3 and 4 illustrate logic flows that may be performed by one or more systems discussed herein to process the transaction in accordance with the settings stored on the contactless card. For example, FIG. 3 includes logic flow 300 that may be performed a contactless card to perform a transaction with a computing device, such as a mobile device or point-of-sale (POS) terminal. Embodiments are not limited in this manner.

At block 302, the logic flow 300 detects a computing device via an interface. For example, the contactless card may detect the presence of a computing device, such as a mobile device or POS terminal, in accordance with a short-range wireless protocol, such as NFC. In some instances, the contactless card may detect the computing device via one or more signals communicated via the EMV chip. In embodiments, the contactless card 100 may not include a power source and may be powered by the coupled interface, e.g., the short-range wireless interface or physical EMV interface. In other instances, the contactless card 100 may include a battery or power source to provide power to perform the operations discussed herein. The contactless card, in response to the detection, may communicate one or more messages with the computing device to establish a communication link with the computing device. The communication exchange may be in accordance with the short-range wireless protocol or the EMV protocol to establish the link, e.g., an NFC exchange or EMV exchange.

At block 304, the logic flow 300 receives an indication of a transaction attempt including characteristics of the transaction. As previously discussed, the characteristics of the transaction may include an amount for the transaction, a location of the transaction, the goods or services for the transaction, a date/time of the transaction, a retailer or provider of the transaction, and so forth. These characteristics may be used by the contactless card 100 to determine whether they exceed and/or are within limits stored on the contactless card 100 to perform transactions.

At decision block 306, the logic flow 300 determines if one or more of the characteristics of the transaction exceeds (or are within) a corresponding limit. The contactless card, including a payment applet, may retrieve limits for transactions stored in memory and compare the characteristics to the limits. For example, the contactless card may determine whether the price of the transaction exceeds a single and/or total transaction spending limit, a location of the transaction is not within a geolocation limit, the retailer or provider is excluded (or not enabled) to provide the good or service.

If the contactless card determines that at least one of the characteristics exceeds at least one of the limits for the transaction, the contactless card may decline the transaction or enable a user to override the limit(s). For example, at decision block 308, the logic flow 300 includes performing a verification operation to verify a user of the contactless card. Decision block 308 may occur in response to at least one of the characteristics exceeding a limit set on the contactless card. As similarly discussed above with respect to FIG. 2, the contactless card, including a verification applet or logic may request and receive a biometric sample from the user via a biometric sensor of the contactless card. The contactless card may compare the collected sample with a stored verified biometric sample to determine whether they match (completely or within a satisfactory threshold amount) or do not match. If the sample matches the stored verified biometric sample, the contactless card may permit or enable the transaction as shown in block 312. If the sample does not match the stored sample, the contactless card may prevent the transaction as shown in block 310. Specifically, at block 310, the logic flow 300 prevent the transaction in response to the transaction, determining that the collected sample does not match the verified sample. In some instances, the contactless card may communicate information to the computing device to deny the transaction.

At block 312, the logic flow 300 includes enabling the transaction. For example and in response to determine the characteristics do not exceed the set limits or the user is verified, the contactless card may communicate information to the computing device to enable the computing device to perform the transaction. For example, the contactless card may communicate a token associated with an account to perform the transaction. Additional information may also be communicated, and the data may be communicated in a cryptogram as discussed herein.

FIG. 4 illustrates a logic flow 400 that may be performed one or more systems discussed herein. In one example embodiment, logic flow 400 may be performed by a computing device such as a mobile device or POS terminal to perform a transaction for a good or service with a contactless card 100.

At block 402, the logic flow 400 receives a transaction attempt to perform a transaction. For example, the computing device may be a POS terminal and include logic to process goods or services being bought by a user. The goods or services may be swiped through a bar scanner and/or include identifying information that may be used by the POS terminal to determine characteristics for the transaction. In another example, the computing device may be a mobile phone or personal computer and the goods or services may be purchased through an app or web interface. The computing device may determine the goods or services and a price associated with the goods or services. In embodiments, the computing device may determine additional data relating to the transaction, such as a location of the transaction, a retailer or provider of the goods or services, a date/time of the transaction, and so forth. The data may be the characteristics of the transaction, e.g., the price, the lists of items, the location, the retailer/provider, date/time, and so forth.

At block 404, the logic flow 400 prompts a user to provide the contactless card within a range of the computing device to communicate and process the transaction or insert the contactless card into a slot to establish a physical coupling (EMV). For example, the computing device may display a message on a display and/or flash an indication via an LED for the user to bring the contactless card within a short-range wireless communication range, e.g., an NFC operating range, or to insert the card into a slot. In embodiments, the computing device may detect the presence of the contactless card once it is in range of the computing device or inserted into the computing device and establish a communication link with the contactless card to communicate data.

At block 406, the logic flow 400 sends a request and transaction data to the contactless card, the request comprising the one or more characteristics associated with the transaction. In embodiments and as discussed in more detail in FIG. 3, the contactless card may perform one or more operations based on the characteristics of the transaction. For example, if the characteristics are within the limits set, the contactless card may provide data to the computing device to process the transaction, e.g., an account token. However, if a characteristic of a transaction exceeds the limit(s), the contactless card may perform one or more operations, as discussed with respect to logic flow 300, to override the limit for the specific transaction, e.g., a one-time override of the limit.

At block 408, the logic flow 400 receives a response from the contactless card. As discussed, if the characteristics do not exceed limits set on the contactless card, the computing device may receive information to process the transaction. If characteristics exceed the limits and/or the contactless card cannot verify the user, the computing device may receive an indication to prevent the transaction.

At block 410, the logic flow 400 processes the transaction. Specifically, the computing device will decline the transaction if the user cannot be verified. If the computing device receives information to process the transaction, the computing device may continue to process the sale until completion.

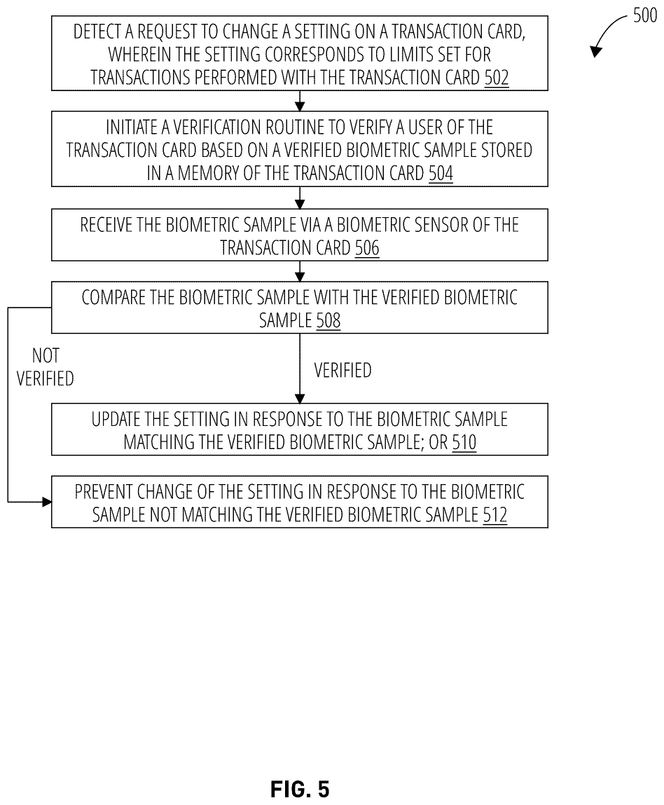

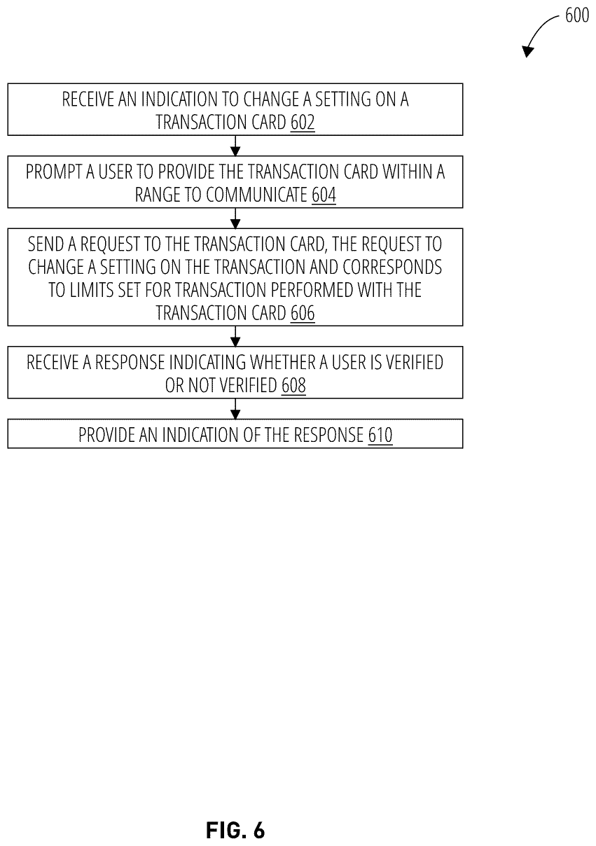

With reference back to FIG. 2, in embodiments, the applets 208, including the payment applet and the verification applet, may perform one or more operations to update and/or change one or more the limit values set for a transaction. FIG. 5 and FIG. 6 illustrate logic flows that may be performed by the systems discussed herein to update settings on the contactless card. For example, FIG. 5 illustrates logic flow 500, which may be performed by a contactless card to change one or more settings or limits on the contactless card.

At block 502, the logic flow 500 detects a request to change at least one setting on a contactless card. The contactless card 100 may receive one or more messages from a computing device via a wireless communication interface the one or more messages may include a data to change one or more settings. For example, the one or more messages may include an identifier to identify a setting to change, e.g., a single transaction spending limit, a total transaction spending limit, a geolocation limit, and service or product provider limit, and so forth. The identifier may be one or more bits that are predefined and correspond to values stored on the contactless card. Further, the one or more messages may include a value to change the setting or limit. For example, the one or more messages may include an identifier to change the total transaction spending limit and include a value of $10,000 to set the limit. Embodiments are no limited in this manner. Other examples, may include setting a geolocation limit to a specific zip code, city, county, state, etc., or setting a service or product provider limit to a store, such as Walmart® or Amazon®. The computing device may be a mobile device, a point-of-sale terminal, or another type of computing device

At block 504, the logic flow 500 initiates a verification routine to verify a user of the contactless card based on a verified biometric sample stored in a memory of the contactless card. For example, the contactless card may initiate a verification applet or logic that may be stored in a secure location of the memory of the contactless card to the process the data associated with changing the setting(s). The verification applet may perform a verification operation or routine to verify the user and that the user has permission to change the one or more settings via a biometric sample collected by the biometric sensor of the contactless card.

At block 506, the logic flow 500 receives the biometric sample via the biometric sensor of the contactless card. For example, the contactless card including the verification applet or logic may receive a biometric sample captured by a biometric sensor, such as a fingerprint sensor on the contactless card. In some embodiments, the contactless card may indicate to the user to provide the biometric sample by an indicator, such as a light emitted diode (LED) embedded on or in the substrate of the card, or through the mobile device or POS terminal. The mobile device or POS terminal my present an indication in a display to provide a biometric sample via the biometric sensor of the contactless card. In embodiments, the biometric sample may be collected and the biometric sensor may operate in accordance with one or more standards, such as those set by the National Institute of Standards and Technology (NIST), e.g., ANSI/NIST-ITL 1-2011, and other standard setting bodies.

At block 508, the logic flow 500 compares the biometric sample with the verified biometric sample. In embodiments, the contactless card including the verification applet or logic may retrieve a verified biometric sample stored in a secure location of the contactless card and compare the verified biometric sample with the captured biometric sample. The verified biometric sample may have been previously collected during configuration operations, e.g., when the contactless card is being initialized. In some embodiments, the verified biometric sample may be received from another device, such as a mobile device over a secure link, and may be updated from time-to-time. The contactless card may compare the biometric sample with the verified biometric sample to determine if they match and/or match above a threshold value, e.g., 90% match. In one example, the verification applet may compare various fingerprint minutiae points of the captured biometric sample with fingerprint minutiae points of the stored biometric sample. In embodiments, the contactless card may store a reduced set of minutiae points for the verified biometric sample. In these embodiments, the verification applet may apply one or more data reduction algorithms to the captured biometric sample to generate a reduced set of captured minutiae to compare with the stored reduced set.

At block 510, the logic flow 500 updates the setting in response to the biometric sample matching the verified biometric sample. The user is verified. In one example, in response to determining the samples matching, the verification applet or logic may send data to a payment applet or logic to cause the setting to update. The data may include the identifier to identify the setting or limit and the value to set the setting or limit. In some embodiments, the verification applet may communicate with the payment applet securely and in accordance with the JAVA® Card applet standard. The payment applet may receive the data, including updating settings and write the data into the memory location(s) corresponding to the setting(s).

At block 512, the logic flow 500 prevents changing of the setting in response to the biometric sample not matching the verified biometric sample. For example, the verification applet or logic may prevent the setting(s) from being updated. In some instances, the verification applet may indicate to the user that the update failed, e.g., via an LED of the contactless card or via communicating a message to a mobile device or POS device to be displayed on a display.

FIG. 6 illustrates a logic flow 600 that may be performed by a computing device or mobile device to change a setting or limit for transactions performed with a contactless card.

At block 602, the logic flow 600 receives an indication to change a setting on a contactless card. For example, a mobile device may include an application or app, such as a banking app, to enable users to interact and perform operations with a contactless card. In embodiments, the mobile device may present options for a user to changes the setting or limits of the card in a graphical user interface (GUI) and may receive one or more inputs via an interface to perform the change. For example, a user may interact with the mobile device to change one or more of a single transaction spending limit, a total transaction spending limit, a geolocation limit, and service or product provider limit. A user may provide a selection of which settings to change and values to change the settings via one or more interfaces.

At block 604, the logic flow 600 prompts a user to provide the contactless card within a range to communicate (NFC) or insert it into a slot (EMV). For example, the mobile device may present a graphic or message on a display indicating to the user to bring the contactless card closer to the mobile device or insert it into a slot of the mobile device or computing device. In one example, the graphic may be a depiction of the contactless card on a display and the user may place the contactless card on the display bringing the card within short range wireless communication, such as a near-field communication (NFC) communication range.

At block 606, the logic flow 600 sends a request to the contactless card to change a setting. The request corresponds to a limit set for the transaction performed with the contactless card. Specifically, the mobile device may exchange one or more messages with the contactless card to establish a communication link with the contactless card and then send one or more messages, including the request to change the setting(s) and values for the setting. The request may include an identifier to identify the setting to change and the value for the setting.

At block 608, the logic flow 600 receives a response indicating whether a user is verified or not verified. In embodiments, the contactless card may perform one or more verification operations to determine whether to update and/or change the setting, such as those discussed with respect to logic flow 500 in FIG. 5. The result of the verification operations may be communicated to the mobile device by the contactless card. Specifically, the response may indicate that the verification operations failed or succeeded based on the outcome of the operations. In block 610, logic flow 600 provides an indication of the response. For example, the mobile device may present on a display an indication of the result of the attempt to change setting or limit.

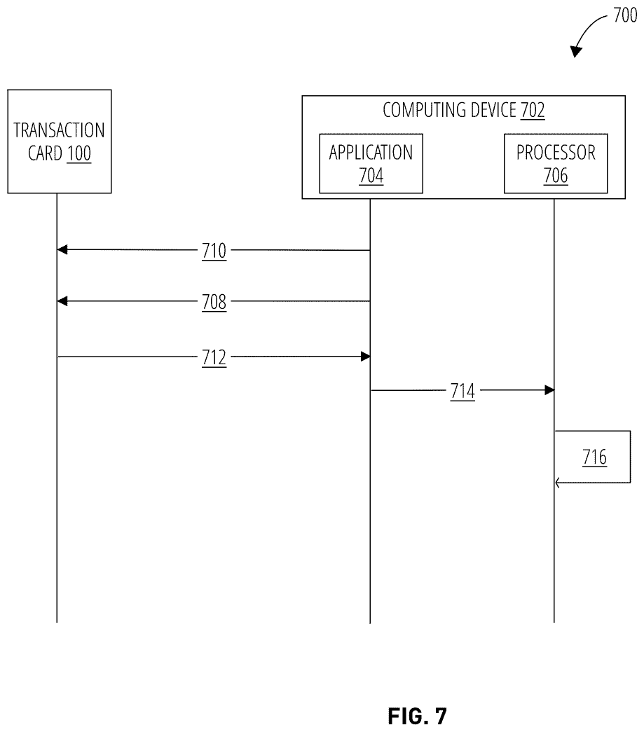

FIG. 7 is a timing diagram illustrating an example sequence for providing authenticated access according to one or more embodiments of the present disclosure. Sequence flow 700 may include contactless card 100 and computing device 702, which may include an application 704 and processor 706.

At line 710, the application 704 communicates with the contactless card 100 (e.g., after being brought near the contactless card 100). Communication between the application 704 and the contactless card 100 may involve the contactless card 100 being sufficiently close to a card reader (not shown) of the computing device 702 to enable NFC data transfer between the application 704 and the contactless card 100.

At line 708, after communication has been established between computing device 702 and contactless card 100, contactless card 100 generates a message authentication code (MAC) cryptogram. In some examples, this may occur when the contactless card 100 is read by the application 704. In particular, this may occur upon a read, such as an NFC read, of a near field data exchange (NDEF) tag, which may be created in accordance with the NFC Data Exchange Format. For example, a reader application, such as application 704, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 100 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 704 may be configured to transmit a request to contactless card 100, the request comprising an instruction to generate a MAC cryptogram.

At line 712, the contactless card 100 sends the MAC cryptogram to the application 704. In some examples, the transmission of the MAC cryptogram occurs via NFC, however, the present disclosure is not limited thereto. In other examples, this communication may occur via Bluetooth, Wi-Fi, or other means of wireless data communication. At line 714, the application 704 communicates the MAC cryptogram to the processor 706.

At line 716, the processor 706 verifies the MAC cryptogram pursuant to an instruction from the application 122. For example, the MAC cryptogram may be verified, as explained below. In some examples, verifying the MAC cryptogram may be performed by a device other than computing device 702, such as a server of a banking system in data communication with the computing device 702. For example, processor 706 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

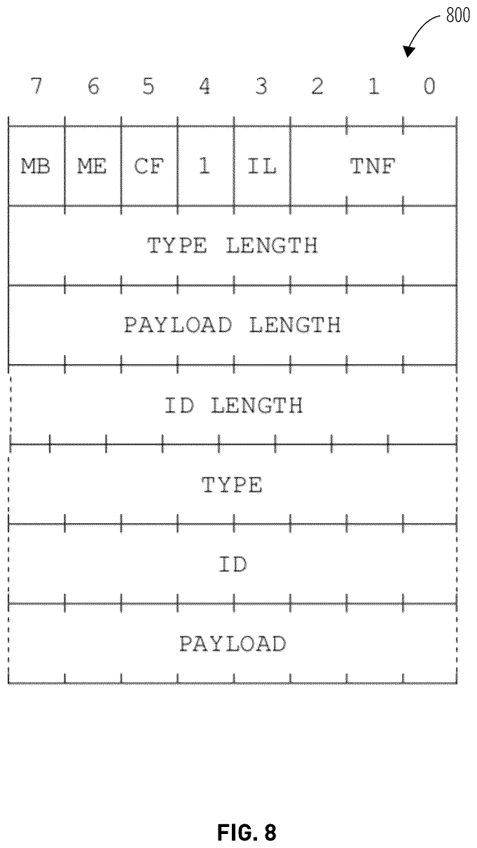

FIG. 8 illustrates an NDEF short-record layout (SR=1) data structure 800 according to an example embodiment. One or more applets may be configured to encode the OTP as an NDEF type 4 well known type text tag. In some examples, NDEF messages may comprise one or more records. The applets may be configured to add one or more static tag records in addition to the OTP record. Exemplary tags include, without limitation, Tag type: well known type, text, encoding English (en); Applet ID: D2760000850101; Capabilities: read-only access; Encoding: the authentication message may be encoded as ASCII hex; type-length-value (TLV) data may be provided as a personalization parameter that may be used to generate the NDEF message. In an embodiment, the authentication template may comprise the first record, with a well-known index for providing the actual dynamic authentication data.

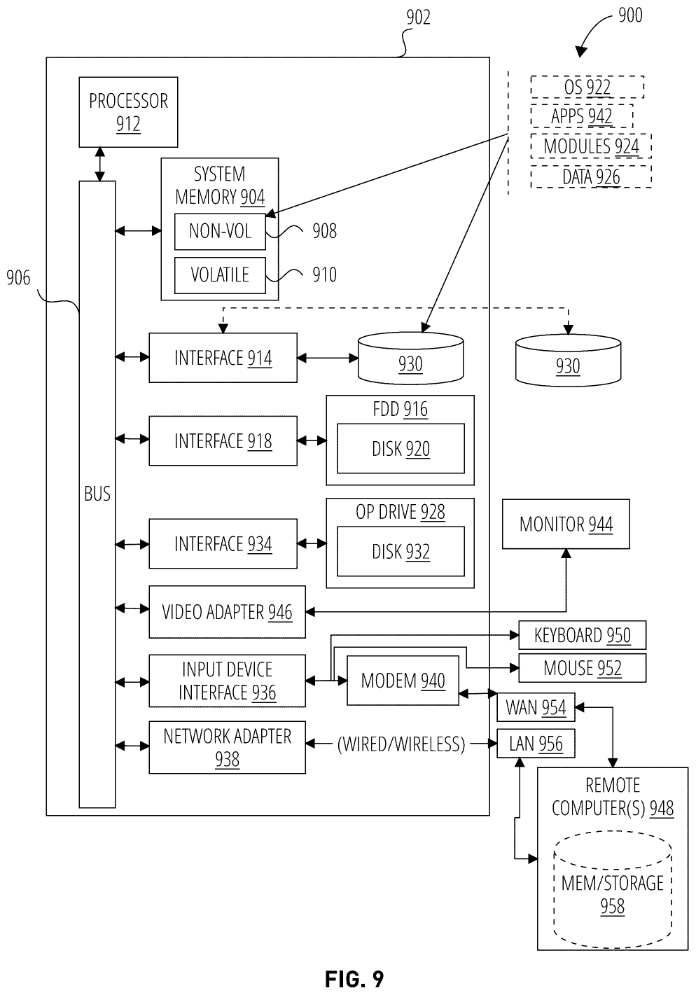

FIG. 9 illustrates an embodiment of an exemplary computer architecture 900 suitable for implementing various embodiments as previously described. In one embodiment, the computer architecture 900 may include or be implemented as part of system, as discussed herein.

As used in this application, the terms “system” and “component” are intended to refer to a computer-related entity, either hardware, a combination of hardware and software, software, or software in execution, examples of which are provided by the exemplary computing computer architecture 900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 100 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 100.

As shown in FIG. 9, the computing architecture 100 includes a processor 912, a system memory 904 and a system bus 906. The processor 912 can be any of various commercially available processors.

The system bus 906 provides an interface for system components including, but not limited to, the system memory 904 to the processor 912. The system bus 906 can be any of several types of bus structure that may further interconnect to a memory bus (with or without a memory controller), a peripheral bus, and a local bus using any of a variety of commercially available bus architectures. Interface adapters may connect to the system bus 906 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 100 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 904 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 9, the system memory 904 can include non-volatile 908 and/or volatile 910. A basic input/output system (BIOS) can be stored in the non-volatile 908.

The computer 902 may include various types of computer-readable storage media in the form of one or more lower speed memory units, including an internal (or external) hard disk drive 930, a magnetic disk drive 916 to read from or write to a removable magnetic disk 920, and an optical disk drive 928 to read from or write to a removable optical disk 932 (e.g., a CD-ROM or DVD). The hard disk drive 930, magnetic disk drive 916 and optical disk drive 928 can be connected to system bus 906 the by an HDD interface 914, and FDD interface 918 and an optical disk drive interface 934, respectively. The HDD interface 914 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 908, and volatile 910, including an operating system 922, one or more applications 942, other program modules 924, and program data 926. In one embodiment, the one or more applications 942, other program modules 924, and program data 926 can include, for example, the various applications and/or components of the systems.

A user can enter commands and information into the computer 902 through one or more wire/wireless input devices, for example, a keyboard 950 and a pointing device, such as a mouse 952. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 912 through an input device interface 936 that is coupled to the system bus 906 but can be connected by other interfaces such as a parallel port, IEEE 1394 serial port, a game port, a USB port, an IR interface, and so forth.

A monitor 944 or other type of display device is also connected to the system bus 906 via an interface, such as a video adapter 946. The monitor 944 may be internal or external to the computer 902. In addition to the monitor 944, a computer typically includes other peripheral output devices, such as speakers, printers, and so forth.

The computer 902 may operate in a networked environment using logical connections via wire and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all the elements described relative to the computer 902, although, for purposes of brevity, only a memory and/or storage device 958 is illustrated. The logical connections depicted include wire/wireless connectivity to a local area network 956 and/or larger networks, for example, a wide area network 954. Such LAN and WAN networking environments are commonplace in offices and companies, and facilitate enterprise-wide computer networks, such as intranets, all of which may connect to a global communications network, for example, the Internet.

When used in a local area network 956 networking environment, the computer 902 is connected to the local area network 956 through a wire and/or wireless communication network interface or network adapter 938. The network adapter 938 can facilitate wire and/or wireless communications to the local area network 956, which may also include a wireless access point disposed thereon for communicating with the wireless functionality of the network adapter 938.

When used in a wide area network 954 networking environment, the computer 902 can include a modem 940, or is connected to a communications server on the wide area network 954 or has other means for establishing communications over the wide area network 954, such as by way of the Internet. The modem 940, which can be internal or external and a wire and/or wireless device, connects to the system bus 906 via the input device interface 936. In a networked environment, program modules depicted relative to the computer 902, or portions thereof, can be stored in the remote memory and/or storage device 958. It will be appreciated that the network connections shown are exemplary and other means of establishing a communications link between the computers can be used.

The computer 902 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.118 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

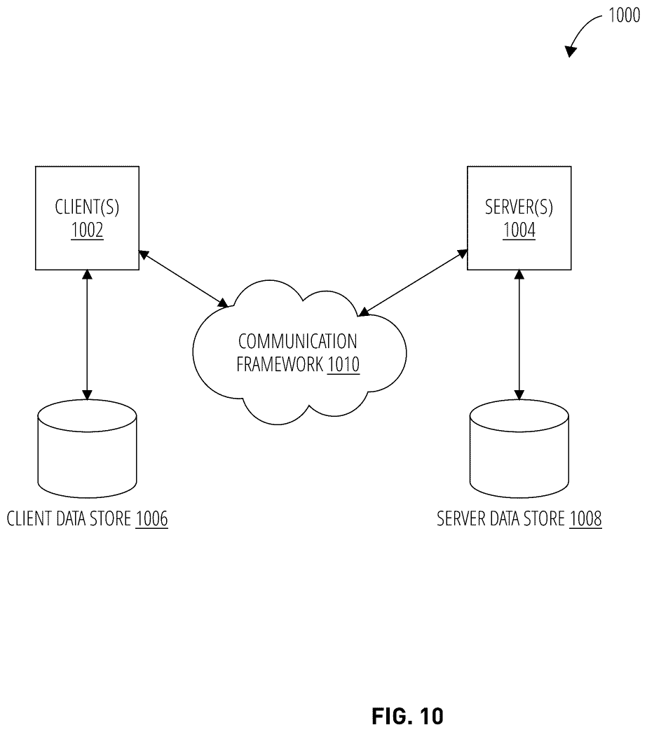

FIG. 10 is a block diagram depicting an exemplary communications architecture 1000 suitable for implementing various embodiments as previously described. The communications architecture 1000 includes various common communications elements, such as a transmitter, receiver, transceiver, radio, network interface, baseband processor, antenna, amplifiers, filters, power supplies, and so forth. The embodiments, however, are not limited to implementation by the communications architecture 1000, which may be consistent with systems or devices discussed herein.

As shown in FIG. 10, the communications architecture 1000 includes one or more client(s) 1002 and server(s) 1004. The server(s) 1004 may implement one or more devices. The client(s) 1002 and the server(s) 1004 are operatively connected to one or more respective client data store 1006 and server data store 1008 that can be employed to store information local to the respective client(s) 1002 and server(s) 1004, such as cookies and/or associated contextual information.

The client(s) 1002 and the server(s) 1004 may communicate information between each other using a communication framework 1010. The communication framework 1010 may implement any well-known communications techniques and protocols. The communication framework 1010 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1010 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by client(s) 1002 and the server(s) 1004. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

1. (canceled)

2. A contactless card, comprising:
a communications interface comprising an antenna and circuitry configured to establish a communication link with an external computing device via a Near-Field Communication (NFC) protocol or an EMV protocol;
a fingerprint sensor configured to capture fingerprint samples;
a processor; and
a memory comprising a non-volatile read/write memory portion and a secure memory portion, the memory storing:
at least one setting corresponding to a transaction limit,
at least one encrypted verified biometric template, the template stored in the secure memory portion,
a payment applet configured to perform payment operations, and
a verification applet configured to perform verification operations, the payment applet and verification application further configured to operate according to a Java Card framework;
wherein the processor is configured to execute the payment applet to:
receive, via the communications interface, one or more Near-Field Communication Data Exchange Format (NDEF) messages from the external computing device, the NDEF messages comprising a request to change the at least one setting, the request including an identifier for the setting and a new value for the setting;
in response to the request, securely initiate a verification routine by sending a message to the verification applet;
cause the verification applet to perform the verification routine by:
receiving a captured fingerprint sample from the fingerprint sensor;
retrieving and decrypting the at least one encrypted verified biometric template from the secure memory portion; and
comparing the captured fingerprint sample with the stored with the decrypted template to verify a user; and
in response to the verification applet verifying the user, cause, by the verification applet, the payment applet to update the at least one setting with the new value, or
in response to the verification applet failing to verify the user, prevent, by the verification applet, the update of the at least one setting.

3. The contactless card of claim 2, wherein the external computing device is one of a point-of-sale terminal, an automatic teller machine (ATM), or a mobile phone device.

4. The contactless card of claim 2, wherein memory portion is a non-volatile read/write memory portion comprising an Electrically Erasable Programmable Read-Only Memory (EEPROM).

5. The contactless card of claim 2, wherein the at least one setting corresponding to a transaction limit comprises a single transaction spending limit, a total transaction spending limit, a geolocation limit, a date/time limit, or combination thereof.

6. The contactless card of claim 2, wherein the fingerprint sensor is one of an optical scanner, a capacitance scanner, an ultrasonic scanner, or a thermal scanner.

7. The contactless card of claim 2, wherein the processor is further configured to execute the payment applet to:
determine that characteristics of a transaction attempt exceed the transaction limit;
in response, initiate the verification routine to verify the user; and
permit the transaction to proceed upon successful verification of the user.

8. The contactless card of claim 2, wherein the memory stores a plurality of encrypted verified biometric templates for a corresponding plurality of users, and wherein each of the plurality of users is associated with a different transaction limit.

9. The contactless card of claim 2, wherein initiating the verification routine comprises providing an indication for the user to provide the fingerprint sample, the indication comprising one of activating a light-emitting diode (LED) on a substrate of the contactless card or sending a message to the external computing device for display.

10. The contactless card of claim 2, wherein the contactless card has physical characteristics compliant with the ID-1 format of the ISO/IEC 7816 standard and is further compliant with the ISO/IEC 14443 standard.

11. The contactless card of claim 2, wherein the at least one encrypted verified biometric template is encrypted using a Triple DES (3DES) algorithm implemented by hardware in the contactless card.

12. A method for controlling settings on a contactless card, the method comprising:
detecting, by a payment applet stored in memory of the contactless card and executing on a processor of the contactless card, a request to change at least one setting on the contactless card, the request received from an external computing device and corresponding to a transaction limit; and
in response to the request, initiating, by the payment applet, a verification routine by sending a message to the verification applet;
receiving, by the verification applet stored in memory of the contactless card and executing on the processor of the contactless card, a captured fingerprint sample from a fingerprint sensor on the card;
retrieving, by the verification applet, at least one encrypted verified biometric template from a secure memory portion of the contactless card;
comparing, by the verification applet, the captured fingerprint sample with the encrypted verified biometric template to verify a user; and
providing, by the verification applet, a result of the verification to the payment applet; and
in response to receiving a result indicating a successful verification, updating, by the payment applet, the at least one setting in a non-volatile read/write memory portion on the card; or
in response to receiving a result indicating a failed verification, preventing, by the payment applet, the update of the at least one setting.

13. The method of claim 12, wherein the external computing device is one of a point-of-sale terminal, an automatic teller machine (ATM), or a mobile phone device.

14. The method of claim 12, wherein the step of updating the at least one setting comprises writing the new value to a non-volatile read/write memory portion that is an Electrically Erasable Programmable Read-Only Memory (EEPROM).

15. The method of claim 12, wherein the at least one setting corresponding to a transaction limit is selected from the group consisting of a single transaction spending limit, a total transaction spending limit, a geolocation limit, and a date/time limit.

16. The method of claim 12, wherein the step of capturing the fingerprint sample is performed by a sensor that is one of an optical scanner, a capacitance scanner, an ultrasonic scanner, or a thermal scanner.

17. The method of claim 12, further comprising the steps of:
determining that characteristics of a transaction attempt exceed the transaction limit;
in response, initiating the verification routine to verify the user; and
permitting the transaction to proceed upon successful verification of the user.

18. The method of claim 12, wherein the step of retrieving comprises retrieving one of a plurality of encrypted verified biometric templates, each template corresponding to a different user and a different transaction limit stored on the card.

19. The method of claim 12, wherein the step of initiating the verification routine further comprises providing an indication for the user to provide the fingerprint sample, the indication comprising one of activating a light-emitting diode (LED) on the contactless card or sending a message to the external computing device for display.

20. The method of claim 12, further comprising the steps of:
receiving, by the payment applet and from the external computing device, a request to perform a transaction, the request including characteristics of the transaction comprising at least a transaction amount and a location;
comparing, by the payment applet, the characteristics of the transaction with the at least one setting to determine that the transaction exceeds the transaction limit; in response to determining that the transaction exceeds the transaction limit, initiating, by the payment applet, the verification routine to obtain a one-time override for the transaction;
performing, by the verification applet, the verification of the user and providing the result to the payment applet; and
in response to a successful verification of the user, enabling, by the payment applet, the transaction to proceed by communicating an account token in a cryptogram to the POS terminal; or
in response to a failed verification, preventing, by the payment applet, the transaction by communicating a decline message to the external computing device.

21. The method of claim 12, wherein the step of retrieving the at least one encrypted verified biometric template comprises decrypting a template that was encrypted using a Triple DES (3DES) algorithm.
